(19) United States
(12) Patent Application Publication
(10) Pub. No.: US 2017/0269688 A1
(43) Pub. Date: Sep. 21, 2017

(54) SYSTEMS AND METHODS FOR PROVIDING HAPTIC FEEDBACK REGARDING SOFTWARE-INITIATED CHANGES TO USER-ENTERED TEXT INPUT

(71) Applicant: Elwha LLC, Bellevue, WA (US)

(72) Inventors: ALISTAIR K. CHAN, BAINBRIDGE ISLAND, WA (US); JESSE R. CHEATHAM, III, SEATTLE, WA (US); RUSSELL J. HANNIGAN, SAMMAMISH, WA (US); RODERICK A. HYDE, REDMOND, WA (US); MURIEL Y. ISHIKAWA, LIVERMORE, CA (US); 3RIC JOHANSON, SEATTLE, WA (US); JORDIN T. KARE, SAN JOSE, CA (US); TONY S. PAN, BELLEVUE, WA (US); CLARENCE T. TEGREENE, MERCER ISLAND, WA (US); CHARLES WHITMER, NORTH BEND, WA (US); LOWELL L. WOOD, JR., BELLEVUE, WA (US); VICTORIA Y.H. WOOD, LIVERMORE, CA (US)

(21) Appl. No.: 15/073,901

(22) Filed: Mar. 18, 2016

(51) Int. Cl. G06F 3/01; G06F 17/27

(52) U.S. Cl. CPC G06F 3/016; G06F 17/276

(57) ABSTRACT

Disclosed embodiments include methods, computer software program products, and systems for providing haptic feedback regarding software-initiated changes to user-entered text input. Given by way of illustration and not of limitation, in an illustrative method a first signal indicative of an autochange to user-entered text is received from an autocorrect module. The autochange is compared to a set of autochange attributes. A second signal is generated by a haptic feedback module responsive to comparing the autochange to a set of autochange attributes. The second signal is provided to a haptic feedback device, and haptic feedback is generated with the haptic feedback device responsive to the second signal.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

None.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### BACKGROUND

This disclosure relates to systems and methods for providing haptic feedback regarding software-initiated changes to user-entered text input.

Several types of software-initiated changes to user-entered text input may be made as a data validation function by various types of text editing software programs, such as word processors, Email, text messaging, and the like. For example, “autocorrect” can, among other things, automatically correct or suggest a correction for common spelling or typing errors made by a user. As another example, “autocomplete” can predict the rest of a word a user is typing.

However, there may be instances when a user may not be aware that autocorrect or autocomplete has either suggested or made a correction or completion, respectively. In some instances, a user may concur with the suggestions made or the corrections or completions automatically made. In some such instances, being unaware of the suggestions or automatic changes may be benign. In some other instances, though, a user may wish to reject suggestions or does not approve of corrections or completions automatically made by autocorrect or autocomplete. In such cases, correcting the unwanted changes by a user entails inefficiencies and waste. In some of these cases, the unwanted changes may not be detected by a user. These undetected, unwanted changes may introduce errors and/or may cause embarrassment to the user.

### SUMMARY

Disclosed embodiments include methods, computer software program products, and systems for providing haptic feedback regarding software-initiated changes to user-entered text input.

In an illustrative method embodiment, a first signal indicative of an autochange to user-entered text is received from an autocorrect module. The autochange is compared to a set of autochange attributes. A second signal is generated by a haptic feedback module responsive to comparing the autochange to a set of autochange attributes. The second signal is provided to a haptic feedback device, and haptic feedback is generated with the haptic feedback device responsive to the second signal.

In an embodiment, an illustrative non-transitory computer-readable storage medium has stored therein instructions which, when executed by a computing device, cause the computing device to perform a method including: receiving from an autocorrect module a first signal indicative of an autochange to user-entered text; comparing the autochange to a set of autochange attributes; generating a second signal with a haptic feedback module responsive to comparing the autochange to a set of autochange attributes; providing the second signal to a haptic feedback device; and generating haptic feedback with the haptic feedback device responsive to the second signal.

In another embodiment, an illustrative system includes a computer processor, a memory, a user interface, a haptic feedback device, and a computer program stored in the memory. The computer program is configured to be executed by the computer processor to perform a method including: receiving from an autocorrect module a first signal indicative of an autochange to user-entered text; comparing the autochange to a set of autochange attributes; generating a second signal with a haptic feedback module responsive to comparing the autochange to a set of autochange attributes; providing the second signal to the haptic feedback device; and generating haptic feedback with the haptic feedback device responsive to the second signal.

In another embodiment, another illustrative non-transitory computer-readable storage medium has stored therein instructions executable by a computing device. The non-transitory computer-readable storage medium includes first computer software program code means for receiving from an autocorrect module a first signal indicative of an autochange to user-entered text. Second computer software program code means compares the autochange to a set of autochange attributes. Third computer software program code means generates a second signal responsive to comparing the autochange to a set of autochange attributes, and fourth computer software program code means causes the second signal to be provided to a haptic feedback device.

In another embodiment, another illustrative system includes a user interface and a computer processor. The computer processor includes: a first computer processing component configured to receive from an autocorrect module a first signal indicative of an autochange to user-entered text; a second computer processing component configured to compare the autochange to a set of autochange attributes; and a third computer processing component configured to generate a second signal responsive to comparing the autochange to a set of autochange attributes. A haptic feedback device is configured to generate haptic feedback responsive to the second signal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a block diagram in partial schematic form of a computing environment in which an illustrative embodiment may be implemented.

FIG. 2 is a block diagram in partial schematic form of another computing environment in which another illustrative embodiment may be implemented.

FIG. 3A is a flowchart of an illustrative method.

FIGS. 3B-3G are flowcharts of details to the method of FIG. 3A.

### DETAILED DESCRIPTION

Disclosed embodiments include methods, computer software program products, and systems for providing haptic feedback regarding software-initiated changes to user-entered text input. It will be appreciated that disclosed embodiments may be implemented with any one or more implementations of hardware, software, and/or firmware as desired for a particular application.

In the following detailed description, reference is made to the accompanying drawings, which form a part hereof. In the drawings, similar symbols typically identify similar components, unless context dictates otherwise. The illustrated embodiments described in the detailed description, drawings, and claims are not meant to be limiting. Other embodiments may be utilized, and other changes may be made, without departing from the spirit or scope of the subject matter presented here.

Those having skill in the art will recognize that the state of the art has progressed to the point where there is little distinction left between hardware, software (e.g., a high-level computer program serving as a hardware specification), and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software (e.g., a high-level computer program serving as a hardware specification), and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software (e.g., a high-level computer program serving as a hardware specification) implementation; or, yet again alternatively, the implementer may opt for some combination of hardware, software (e.g., a high-level computer program serving as a hardware specification), and/or firmware in one or more machines, compositions of matter, and articles of manufacture, limited to patentable subject matter under 35 U.S.C. §101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software (e.g., a high-level computer program serving as a hardware specification), and or firmware.

In some implementations described herein, logic and similar implementations may include software or other control structures suitable to implement an operation. Electronic circuitry, for example, may manifest one or more paths of electrical current constructed and arranged to implement various logic functions as described herein. In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described below. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, module, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will also recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will further recognize that at least a portion of the devices and/or processes described herein can be integrated into an image processing system. A typical image processing system may generally include one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will likewise recognize that at least some of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software (e.g., a high-level computer program serving as a hardware specification)).

Importantly, although the operational/functional descriptions described herein are understandable by the human mind, they are not abstract ideas of the operations/functions divorced from computational implementation of those operations/functions. Rather, the operations/functions represent a specification for massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to a human reader. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail herein, these logical operations/functions are not representations of abstract ideas, but rather are representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood by a human reader). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of logic, such as Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configurations, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible to most humans. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that useful, tangible, and concrete work is done. For example, as indicated above, such machine language—the compiled version of the higher-level language—functions as a technical specification which selects out hardware logic gates, specifies voltage levels, voltage transition timings, etc., such that the useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality of logic(s), or (d) virtually any combination of the foregoing. Indeed, any physical object which has a stable, measurable, and changeable state may be used to construct a machine based on the above technical description. Charles Babbage, for example, constructed the first mechanized computational apparatus out of wood, with the apparatus powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language should not be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software (e.g., a high-level computer program serving as a hardware specification) or firmware, or of gate arrays or programmable hardware, such as by performing a reception of or a transmission of one or more instructions in relation to one or more operations described herein. Alternatively or additionally, in some variants, an implementation may include special-purpose hardware, software (e.g., a high-level computer program serving as a hardware specification), firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

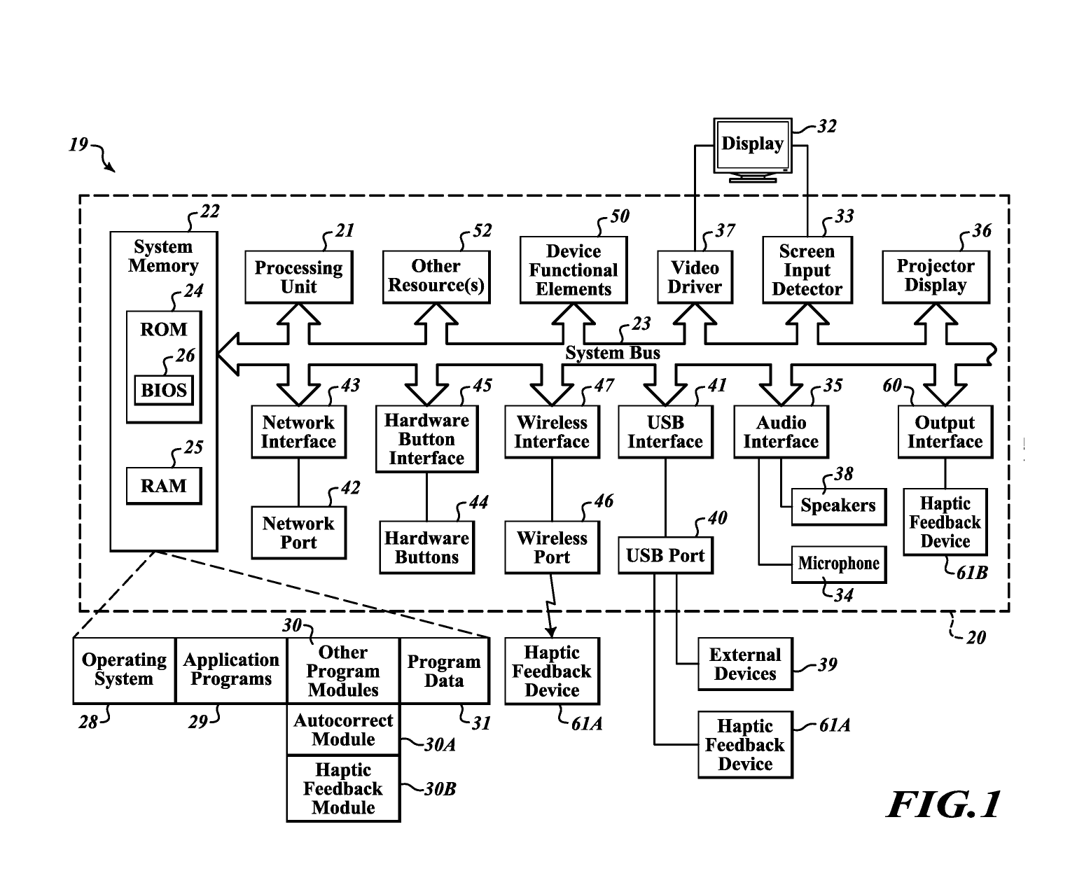

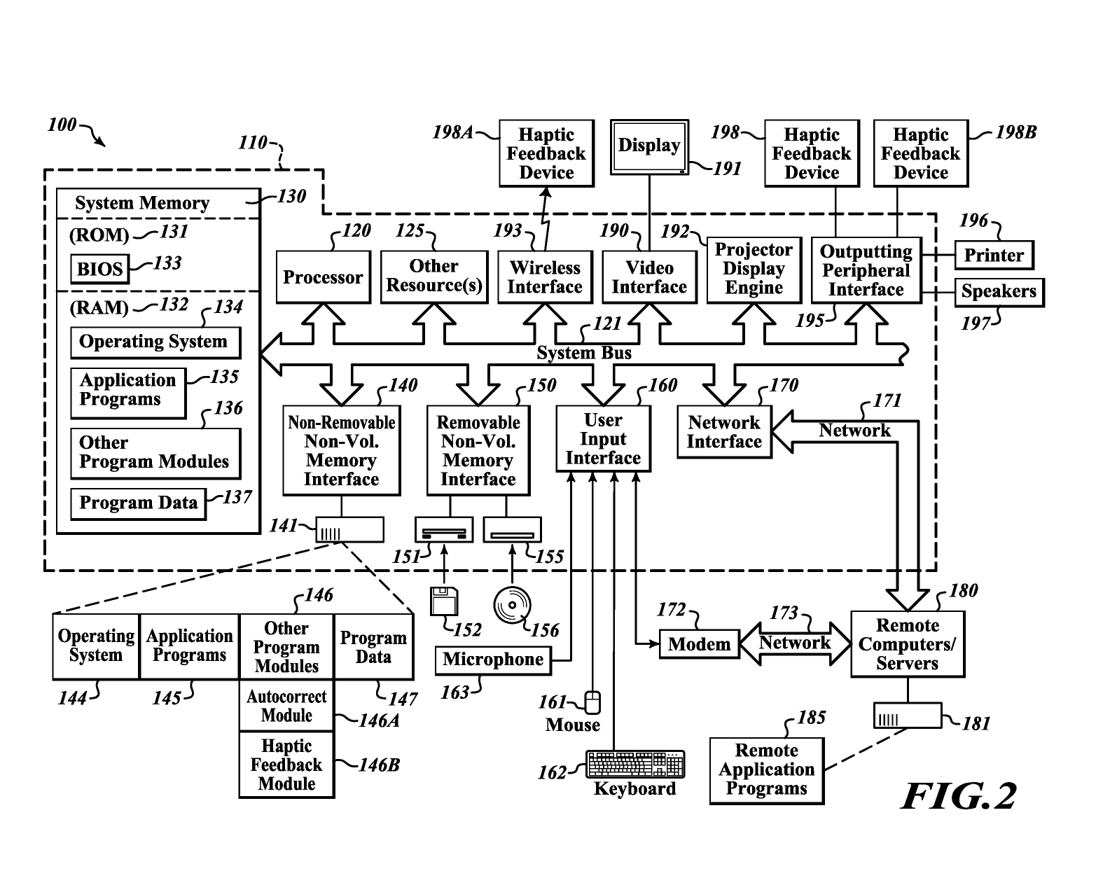

FIGS. 1 and 2 provide respective general descriptions of several environments in which implementations may be implemented. Referring to FIGS. 1 and 2 and by way of non-limiting overview of an embodiment presented by way of illustration and not of limitation, illustrative systems 19 (FIG. 1) and 100 (FIG. 2) include a computer processor 21 (FIG. 1) and 120 (FIG. 2) respectively, a memory 22 (FIG. 1) and 130 (FIG. 2) respectively, a user interface 32, 33, 34, 35, 36, 44, and 45 (all FIG. 1) and 160, 161, 162, 163, 190, 191, 195, 196, and 197 (all FIG. 2) respectively, a haptic feedback device 61, 61A, and 61B (FIG. 1) and 198, 198A, and 198B (FIG. 2) respectively, and a computer program 30B (FIG. 1) and 146B (FIG. 2) respectively stored in the memory 22 (FIG. 1) and 130 (FIG. 2) respectively. The computer program 30B (FIG. 1) and 146B (FIG. 2) is configured to be executed by the computer processor 21 (FIG. 1) and 120 (FIG. 2) respectively to perform a method including: receiving from an autocorrect module 30A (FIG. 1) and 146A (FIG. 2) respectively a first signal indicative of an autochange to user-entered text; comparing the autochange to a set of autochange attributes; generating a second signal with a haptic feedback module 30B (FIG. 1) and 146B (FIG. 2) respectively responsive to comparing the autochange to a set of autochange attributes; providing the second signal to the haptic feedback device 61, 61A, and 61B (FIG. 1) and 198, 198A, and 198B (FIG. 2) respectively; and generating haptic feedback with the haptic feedback device 61, 61A, and 61B (FIG. 1) and 198, 198A, and 198B (FIG. 2), respectively, responsive to the second signal.

FIG. 1 is generally directed toward a thin computing environment 19 having a thin computing device 20, and FIG. 2 is generally directed toward a general purpose computing environment 100 having general purpose computing device 110. However, as prices of computer components drop and as capacity and speeds increase, there is not always a bright line between a thin computing device and a general purpose computing device. Further, there is a continuous stream of new ideas and applications for environments benefited by use of computing power. As a result, nothing should be construed to limit disclosed subject matter herein to a specific computing environment unless limited by express language.

FIG. 1 and the following discussion are intended to provide a brief, general description of a thin computing environment 19 in which embodiments may be implemented. FIG. 1 illustrates an example system that includes a thin computing device 20, which may be included or embedded in an electronic device that also includes a device functional element 50. For example, the electronic device may include any item having electrical or electronic components playing a role in a functionality of the item, such as for example, a refrigerator, a car, a digital image acquisition device, a camera, a cable modem, a printer an ultrasound device, an x-ray machine, a non-invasive imaging device, or an airplane. For example, the electronic device may include any item that interfaces with or controls a functional element of the item. In another example, the thin computing device may be included in an implantable medical apparatus or device. In a further example, the thin computing device may be operable to communicate with an implantable or implanted medical apparatus. For example, a thin computing device may include a computing device having limited resources or limited processing capability, such as a limited resource computing device, a wireless communication device, a mobile wireless communication device, a smart phone, an electronic pen, a handheld electronic writing device, a scanner, a cell phone, a smart phone (such as an Android® or iPhone® based device), a tablet device (such as an iPad®) or a Blackberry® device. For example, a thin computing device may include a thin client device or a mobile thin client device, such as a smart phone, tablet, notebook, or desktop hardware configured to function in a virtualized environment.

The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 or RAM 25, including an operating system 28, one or more application programs 29, other program modules 30 (such as an autocorrect module 30A and a haptic feedback module 30B, both discussed below), and program data 31.

A user may enter commands and information into the computing device 20 through one or more input interfaces. An input interface may include a touch-sensitive display, or one or more switches or buttons with suitable input detection circuitry. A touch-sensitive display is illustrated as a display 32 and screen input detector 33. One or more switches or buttons are illustrated as hardware buttons 44 connected to the system via a hardware button interface 45. The output circuitry of the touch-sensitive display 32 is connected to the system bus 23 via a video driver 37. Other input devices may include a microphone 34 connected through a suitable audio interface 35, or a physical hardware keyboard (not shown). Output devices may include the display 32, or a projector display 36.

In addition to the display 32, the computing device 20 may include other peripheral output devices, such as at least one speaker 38. Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. Various embodiments may include a haptic feedback device 61 (discussed below) that may be connected to the processing unit 21 through the USB port 40, the USB port interface 41, and the system bus 23 or may be connected by other interfaces, such as a parallel port, game port, or other port. The computing device 20 may further include or be capable of connecting to a flash card memory (not shown) through an appropriate connection port (not shown). The computing device 20 may further include or be capable of connecting with a network through a network port 42 and network interface 43, and wirelessly (such as via WiFi and/or Bluetooth connectivity) through wireless port 46 and corresponding wireless interface 47 may be provided to facilitate communication with other peripheral devices, including other computers, printers, and so on (not shown). In various embodiments, a haptic feedback device 61A (discussed below) may be connected to the processing unit 21 via the wireless port 46 and corresponding wireless interface 47. In some embodiments, an internal haptic feedback device 61B (discussed below) may be connected to the processing unit 21 through an output interface 60 and the system bus 23. It will be appreciated that the various components and connections shown are examples and other components and means of establishing communication links may be used.

The computing device 20 may be primarily designed to include a user interface. The user interface may include a character, a key-based, or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and are coupled with the system bus 23 through an interface (not shown). The functional elements may typically perform a single well-defined task with little or no user configuration or setup, such as a refrigerator keeping food cold, a cell phone connecting with an appropriate tower and transceiving voice or data information, a camera capturing and saving an image, or communicating with an implantable medical apparatus.

In certain instances, one or more elements of the thin computing device 20 may be deemed not necessary and omitted. In other instances, one or more other elements may be deemed necessary and added to the thin computing device.

FIG. 2 and the following discussion are intended to provide a brief, general description of an environment in which embodiments may be implemented. FIG. 2 illustrates an example embodiment of a general-purpose computing system in which embodiments may be implemented, shown as a computing system environment 100. Components of the computing system environment 100 may include, but are not limited to, a general purpose computing device 110 having a processor 120, a system memory 130, and a system bus 121 that couples various system components including the system memory to the processor 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media. By way of further example, and not of limitation, computer-readable media may include a communication media.

Computer storage media includes volatile and nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, or atomic quantum memory. Combinations of any of the above may also be included within the scope of computer-readable media.

Communication media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media may include wired media, such as a wired network and a direct-wired connection, and wireless media such as acoustic, RF, optical, and infrared media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by the processor 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS”® are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable non-volatile memory interface 150 that, for example, is coupled to a magnetic disk drive 151 that reads from and writes to a removable, non-volatile magnetic disk 152, or is coupled to an optical disk drive 155 that reads from and writes to a removable, non-volatile optical disk 156, such as a CD ROM. Other removable/non-removable, volatile/non-volatile computer storage media that can be used in the example operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146 (such as an autocorrect module 146A and a haptic feedback module 146B, both discussed below), and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies.

A user may enter commands and information into the computing device 110 through input devices such as a microphone 163, keyboard 162, and pointing device 161, commonly referred to as a mouse, trackball, or touch pad. Other input devices (not shown) may include at least one of a touch sensitive display, joystick, game pad, satellite dish, and scanner. These and other input devices are often connected to the processor 120 through a user input interface 160 that is coupled to the system bus, but may be connected by other interface and bus structures, such as a parallel port, game port, or a universal serial bus (USB).

A display 191, such as a monitor or other type of display device or surface may be connected to the system bus 121 via an interface, such as a video interface 190. A projector display engine 192 that includes a projecting element may be coupled to the system bus. In addition to the display, the computing device 110 may also include other peripheral output devices such as speakers 197 and printer 196, which may be connected through an output peripheral interface 195.

In various embodiments, a haptic feedback device 198 (discussed below) may be connected to the processor 120 through the outputting peripheral interface 195 and the system bus 121 or may be connected by other interfaces, such as a parallel port, game port, or other port. In various embodiments, a haptic feedback device 198A (discussed below) may be connected wirelessly (such as via WiFi and/or Bluetooth connectivity) to the processor 120 via the wireless interface 193 and the system bus 121. In some embodiments, an internal haptic feedback device 198B (discussed below) may be connected to the processor 120 through the outputting peripheral interface 195 and the system bus 121 or may be connected by other interfaces, such as a parallel port, game port, or other port.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The network logical connections depicted in FIG. 2 include a local area network (LAN) and a wide area network (WAN), and may also include other networks such as a personal area network (PAN) (not shown). Such networking environments are commonplace in offices, enterprise-wide computer networks, intranets, and the Internet.

When used in a networking environment, the computing system environment 100 is connected to the network 171 through a network interface, such as the network interface 170, the modem 172, or the wireless interface 193. The network may include a LAN network environment, or a WAN network environment, such as the Internet. In a networked environment, program modules depicted relative to the computing device 110, or portions thereof, may be stored in a remote memory storage device. By way of example, and not limitation, FIG. 2 illustrates remote application programs 185 as residing on memory storage device 181. It will be appreciated that the network connections shown are examples and other means of establishing communication link between the computers may be used.

In certain instances, one or more elements of the computing device 110 may be deemed not necessary and omitted. In other instances, one or more other elements may be deemed necessary and added to the computing device.

Still referring to FIGS. 1 and 2, the autocorrect modules 30A (FIG. 1) and 146A (FIG. 2) suitably make any one or more of several types of software-initiated changes to user-entered text input as a data validation function by various types of text editing software programs, such as word processors, Email, text messaging, and the like. In some embodiments, the autocorrect modules 30A (FIG. 1) and 146A (FIG. 2) suitably may be part of any of the application programs 29 (FIG. 1) or 145 (FIG. 2), respectively. In some embodiments, the autocorrect modules 30A (FIG. 1) and 146A (FIG. 2) suitably may be provided as stand-alone modules that work in association with, but are not part of, text editing software programs.

In some embodiments, the autocorrect modules 30A (FIG. 1) and 146A (FIG. 2) suitably implement an “autocorrect” function that can automatically correct or suggest a correction for common spelling or typing errors made by a user. In some instances, autocorrect can automatically format text or insert special characters by recognizing particular character usage. In addition, in some instances autocorrect can: recognize words that have been typed with more than one initial capital letter and can correct them to have only an initial capital letter; capitalize the first letters of sentences; and correct accidental use of caps lock. Typically, autocorrect is presented to the left of cursor location.

In some embodiments, the autocorrect modules 30A (FIG. 1) and 146A (FIG. 2) suitably implement an “autocomplete” function that can predict the rest of a word a user is typing. In a graphical user interface, a user can typically press the tab key or the space bar to accept a suggestion or the down arrow key to accept one of several suggestions. Autocomplete's effectiveness may be increased in domains with a limited number of possible words (such as in command line interpreters), when some words are much more common (such as when addressing an Email message), and/or when writing structured and predictable text (as in source code editors). Some autocomplete algorithms may learn new words after the user has written them a few times, and can suggest alternatives based on the learned habits of the individual user. Typically, autocomplete is presented to the right of cursor location.

Still referring to FIGS. 1 and 2, in various embodiments the haptic feedback modules 30B (FIG. 1) and 146B (FIG. 2) generate a signal responsive to comparing the autochange to a set of autochange attributes (discussed below). The haptic feedback modules 30B (FIG. 1) and 146B (FIG. 2) suitably may be implemented with software, firmware, hardware, and/or any combination thereof.

Haptic feedback is generated by any suitable haptic feedback device as desired for a particular application. In some embodiments, the haptic feedback devices 61B (FIG. 1) and 198B (FIG. 2) are internal haptic feedback devices. That is, the haptic feedback devices 61B (FIG. 1) and 198B (FIG. 2) suitably are disposed as desired within a case that houses the thin computing device 20 (FIG. 1) or the general purpose computing device 110 (FIG. 2). Given by way of non-limiting example, when the thin computing device 20 (FIG. 1) or the general purpose computing device 110 (FIG. 2) is embodied as a smart phone, a tablet computing device, or a laptop computer, the haptic feedback device 61B (FIG. 1) and 198B (FIG. 2) may be located within the case of the smart phone, tablet computing device, or laptop computer. In such cases, if desired the haptic feedback devices 61B (FIG. 1) and 198B (FIG. 2) may be located proximate a virtual keyboard section of the display 32 (FIG. 1) of a smart phone or a tablet computing device, or proximate keys of the keyboard 162 of a laptop computer. In the example of a smart phone, the haptic feedback device 61B (FIG. 1) may be embodied as the pre-existing cellphone vibrator provided within the smart phone. The haptic feedback device 61B (FIG. 1) and 198B (FIG. 2) suitably may be embodied as any device that is configured to create mechanical stimulation by imparting forces, vibrations, or motions to a user. Given by way of illustration and not of limitation, the haptic feedback device 61B (FIG. 1) and 198B (FIG. 2) suitably may be provided as: an electromagnetic motor (which typically vibrates the whole device in which it is disposed rather than an individual section), an electromechanic membrane actuator, a magnetic buzzer, an electromagnetic device (such as a buzzer, a pricker, or the like), a pneumatic device, an electropneumatic device, electroactive polymers, a piezoelectric actuator, an electrostatic actuator, and a subsonic audio wave surface actuator (which can permit localization of haptic response to a desired location). The haptic actuators and devices discussed above are well known to those of skill in the art, and a detailed description of their construction and operation is not necessary for understanding by one of skill in the art.

In some embodiments, the haptic feedback devices 61 and 61A (FIG. 1) and 198 and 198A (FIG. 2) are external haptic feedback devices. That is, the haptic feedback devices 61 and 61A (FIG. 1) and 198 and 198A (FIG. 2) suitably are disposed as desired exterior a case that houses the thin computing device 20 (FIG. 1) or the general purpose computing device 110 (FIG. 2). The haptic feedback device 61 and 61A (FIG. 1) and 198 and 198A (FIG. 2) also suitably may be embodied as any device that is configured to create mechanical stimulation by imparting forces, vibrations, or motions to a user. Given by way of illustration and not of limitation, the device 61 and 61A (FIG. 1) and 198 and 198A (FIG. 2) suitably may be provided as: an electromagnetic motor (which typically vibrates the whole device in which it is disposed rather than an individual section), an electromechanic membrane actuator, a magnetic buzzer, or the like; electroactive polymers, a piezoelectric actuator, an electrostatic actuator, and a subsonic audio wave surface actuator (which can permit localization of haptic response to a desired location); at least one glove; at least one finger cot; at least one fingertip applique; at least one ring; at least one wristband; and at least one palm rest. The haptic actuators and devices discussed above are well known to those of skill in the art, and a detailed description of their construction and operation is not necessary for understanding by one of skill in the art.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

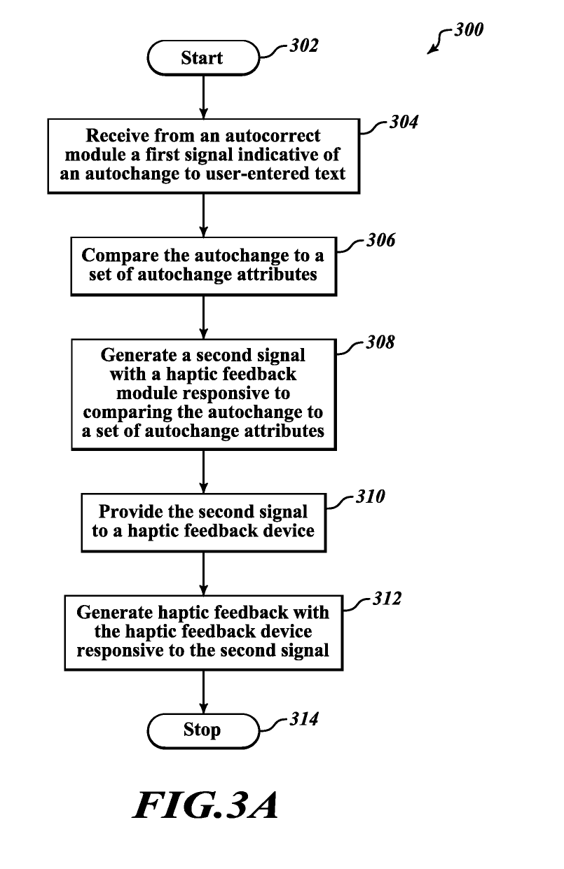

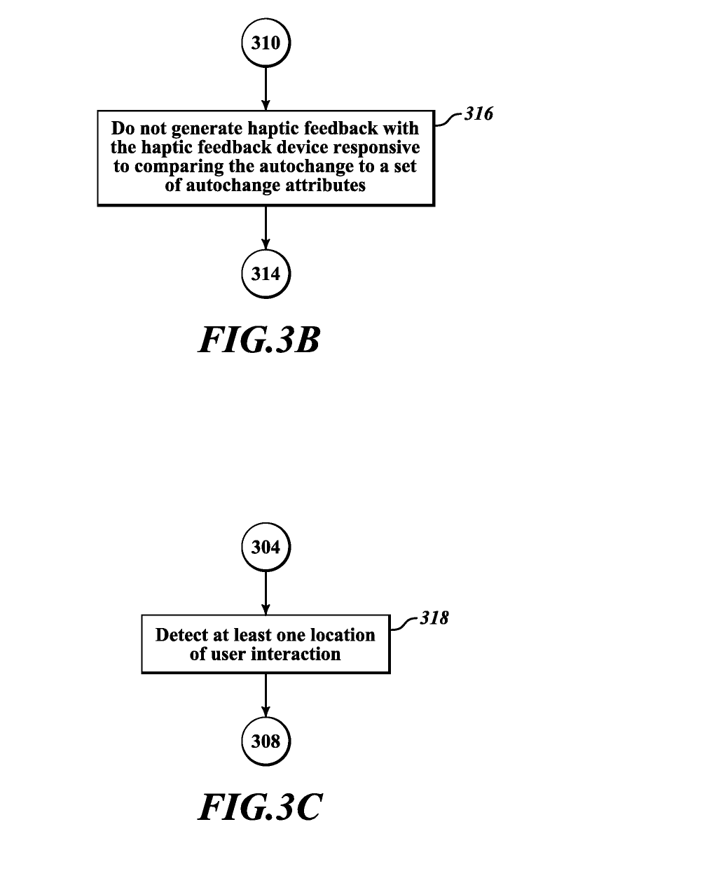

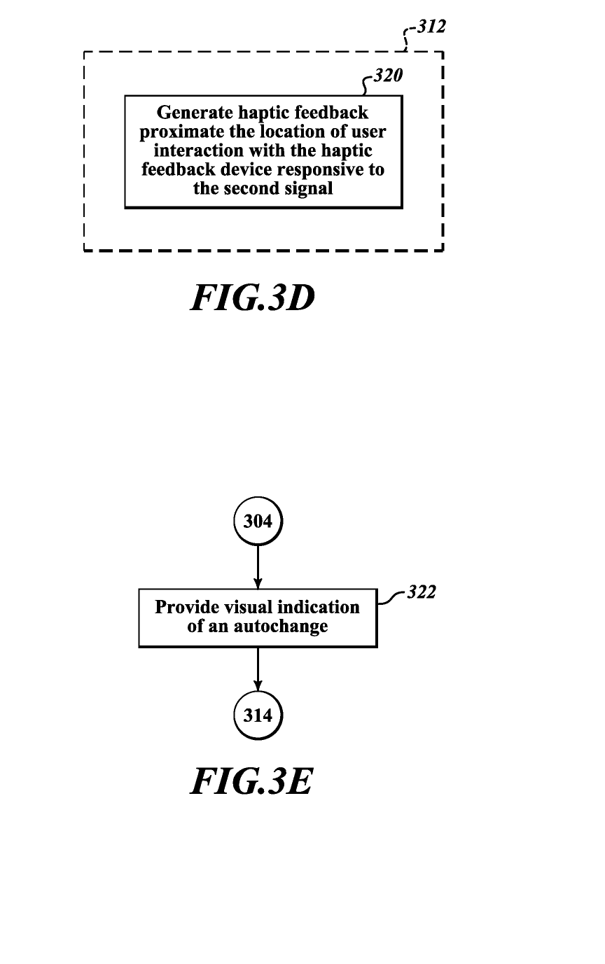

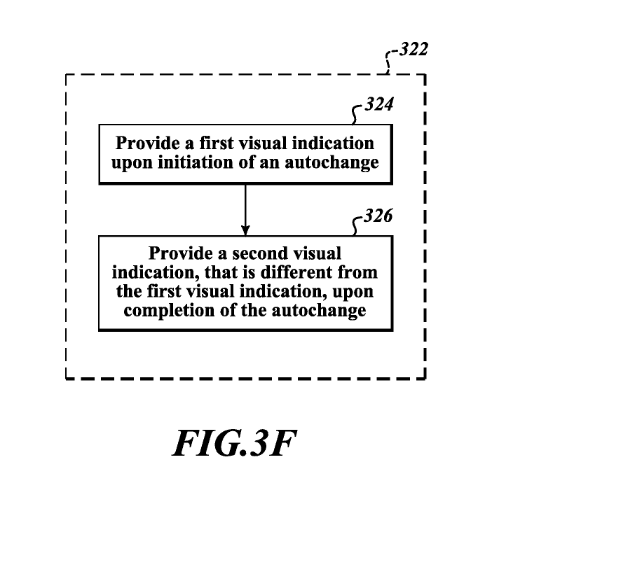

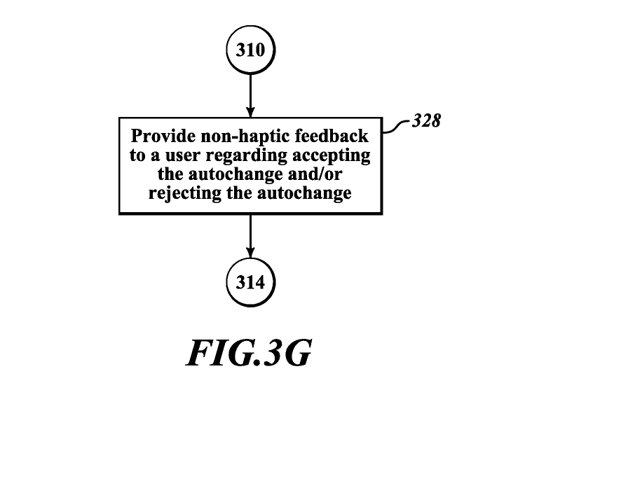

Referring now to FIG. 3A, an illustrative method 300 is provided for providing haptic feedback regarding software-initiated changes to user-entered text input. It will be appreciated that the method 300 may be implemented via hardware, software, firmware components, and/or general-purpose components executing or otherwise invoking special-purpose components.

The method 300 starts at a block 302. At a block 304 a first signal indicative of an autochange to user-entered text is received from an autocorrect module. At a block 306 the autochange is compared to a set of autochange attributes. At a block 308 a second signal is generated with a haptic feedback module responsive to comparing the autochange to a set of autochange attributes. At a block 310 the second signal is provided to a haptic feedback device. At a block 312 haptic feedback is generated with the haptic feedback device responsive to the second signal. The method 300 stops at a block 314.

In some embodiments, the autochange may be a software-initiated change event such as a software-initiated-and-accomplished change to user-entered text (for example, autocomplete) or a software-initiated-and-recommended change to user-entered text (for example, autocorrect).

Different autochange events may result in generation of different types of haptic feedback. In some embodiments, the second signal causes generation of haptic feedback with a haptic attribute that correlates with a property of the autochange. For example, the second signal causes generation of haptic feedback with a first haptic attribute when the autochange has a first autochange property, and the second signal causes generation of haptic feedback with a second haptic attribute that is different from the first haptic attribute when the autochange has a second autochange property.

As an example, the first autochange property may include autocorrection and the second autochange property may include autocompletion. In such a case, the first haptic attribute may include location on a first side of a user's digit and the second haptic attribute may include location on a second side of a user's digit that is different from the first side of the user's digit. Generation of haptic feedback on a first side of a user's digit and a second side of a user's digit that is different from the first side of a user's digit may be effected with any one or more of haptic feedback devices such as a finger cot, a ring, a glove, or the like. Also, any two (or more) haptic feedback devices as desired may be disposed within a case in which the computing processor is disposed such that they are spaced apart on different sides of a user's digit in order to generate haptic feedback on a first side of a user's digit and a second side of a user's digit that is different from the first side of a user's digit. In some embodiments, autocorrect can cause generation of haptic feedback on the left side of a user's finger and autocomplete can cause generation of haptic feedback on the right side of a user's finger. In such a case, autocorrect can be likened to an event that has a “backward” direction associated therewith and autocomplete can be likened to an event that has a “forward” direction associated therewith. However, in some embodiments, if desired autocorrect can cause generation of haptic feedback on the right side of a user's finger and autocomplete can cause generation of haptic feedback on the left side of a user's finger.

In various embodiments, the haptic attribute may include proximity of haptic stimulation to a user's digit that entered text subject to the autochange, duration of haptic stimulation, type of haptic stimulation, location of haptic stimulation, temporal and/or spatial distribution of haptic stimulation, intensity of haptic stimulation, and/or frequency of haptic stimulation. Also, in various embodiments the type of haptic stimulation may include vibration, impulse, tap, force, change in force, pressure, change in pressure, pinprick, electric stimulation, and/or change in texture. Moreover, in some embodiments different types of haptic stimulation may be generated for different types of errors or events that prompted an autochange event. That is, given by way of non-limiting examples different types of haptic stimulation may be provided for misspelling versus word changes versus grammatical errors versus punctuation errors, and the like.

As discussed above, the autochange may include a software-initiated correction event to user-entered text, such as autocorrection. In such a case, the software-initiated correction event to user-entered text may include a correction such as a spelling correction, a typographical error correction, a capitalization correction, a punctuation correction, a grammar correction, a spacing correction, and/or a formatting correction.

As also discussed above, the autochange may also include a software-initiated autocompletion event to user-entered text.

In some embodiments, the autochange may include a software-initiated substitution event to user-entered text. In such cases, the software-initiated substitution event to user-entered text may include a substitution of user-preferred terminology, a substitution of a synonym, a substitution of at least one word for an abbreviation, a substitution of an abbreviation for at least one word, and/or a substitution of at least one predetermined word for at least one other predetermined word, such as for example substitution to profanity of a sexual synonym.

Referring additionally to FIG. 3B, at a block 316 in some embodiments the method 300 may further include not generating the second signal responsive to comparing the autochange to a set of autochange attributes. In some such cases, the set of autochange attributes may include a dictionary file, a predetermined word list, a vocabulary list, a user-provided glossary, synonyms, probability estimates, predetermined words, user-provided rules, and/or user-provided algorithms. Given by way of non-limiting examples, the second signal may not be generated if autocorrect replaces two spaces with one space unless this replacement occurs after a period, if autocorrect makes a formatting correction (such as properly indenting a paragraph), if autocorrect corrects a common mistake that has a high probability of actually being desired to be corrected (such as “teh” for “the”), and/or the like.

In some other such cases, the set of autochange attributes may include at least one learned response. For example, the learned response may include determining whether to generate the second signal based on whether a user rejected the autochange, determining whether to generate the second signal based on how often a user rejects the autochange, modifying a rule in a set of rules in response to a user overriding the autocorrection, and/or adding a new rule to a set of rules in response to a user overriding the autocorrection. Given by way of illustration and not of limitation, in some embodiments a new rule may be added to a set of rules if autocorrect or autocomplete suggests a word but a user types a word that is different from the word that is suggested by autocorrect or autocomplete.

Additional non-limiting examples of instances when the second signal may be generated may include: autocorrect corrects two capital letters (for example, TWo CApital letters); autocorrect corrects two capital letters (for example, TWo CApital letters) if a user has previously used that capital letter pair in the same document or in any document; autocorrect corrects two capital letters (for example, TWo CApital letters) anywhere in a document except at the beginning of a sentence (for example, generate the second signal if autocorrect corrects a unit such as THz or the like—but do not generate the second signal if autocorrect corrects two capital letters such as “THe” at the beginning of the sentence and instead permit autocorrect to change “THe” to “The” at the beginning of a sentence without generation of haptic feedback;

Referring back to FIG. 3A, in some embodiments generating the second signal responsive to comparing the autochange to a set of autochange attributes at the block 308 may be further responsive to response from a user. In such cases, the response from a user may be indicative of acceptance of the autochange and/or rejection of the autochange.

In some embodiments, generation of haptic feedback may be combined with detecting a response by a user. Referring additionally to FIGS. 3C and 3D, in some embodiments the method 300 may further include detecting at least one location of user interaction at a block 318, wherein generating haptic feedback with the haptic feedback device responsive to the second signal at the block 312 includes generating haptic feedback proximate the location of user interaction with the haptic feedback device responsive to the second signal at a block 320. In various embodiments, the response by a user may be a motion, such as a finger motion, a swipe, a key tap, or the like, that may indicate acceptance of a change or rejection of a change.

Referring additionally to FIG. 3E, in some embodiments the method 300 may further include providing visual indication of an autochange at a block 322. Referring additionally to FIG. 3F, providing visual indication of an autochange at the block 322 may include providing a first visual indication upon initiation of an autochange at a block 324 and providing a second visual indication, that is different from the first visual indication, upon completion of the autochange at a block 326.

Referring additionally to FIG. 3G, in some embodiments the method 300 may also include providing non-haptic feedback to a user regarding accepting the autochange and/or rejecting the autochange at a block 328. Given by way of illustration and not of limitation, in some embodiments the haptic feedback may be generated in conjunction with an enhanced way for a user to accept or reject a suggested change. Given by way of non-limiting examples, large symbols such as a large “OK” button or a large “Reject” button may be displayed on a touchscreen, or a key that may accept a suggested change may be highlighted, or a key that may reject a suggested change may be highlighted, or the like.

As discussed above, the method 300 may be implemented via hardware, software, firmware components, and/or general-purpose components executing or otherwise invoking special-purpose components. To that end, some embodiments provide a non-transitory computer-readable storage medium having stored therein instructions which, when executed by a computing device, cause the computing device to perform the method 300 including: receiving from an autocorrect module a first signal indicative of an autochange to user-entered text; comparing the autochange to a set of autochange attributes; generating a second signal with a haptic feedback module responsive to comparing the autochange to a set of autochange attributes; providing the second signal to a haptic feedback device; and generating haptic feedback with the haptic feedback device responsive to the second signal. It will be appreciated that in various embodiments the instructions stored in the non-transitory computer-readable storage medium may cause the computing device to perform any one or more of the details set forth above regarding any of the aspects of embodiments of the method 300.

Similarly, some embodiments provide a system including: a computer processor; a memory; a user interface; a haptic feedback device; and a computer program stored in the memory, wherein the computer program is configured to be executed by the computer processor to perform the method 300 including: receiving from an autocorrect module a first signal indicative of an autochange to user-entered text; comparing the autochange to a set of autochange attributes; generating a second signal with a haptic feedback module responsive to comparing the autochange to a set of autochange attributes; providing the second signal to the haptic feedback device; and generating haptic feedback with the haptic feedback device responsive to the second signal. It will be appreciated that in various embodiments the instructions stored in the non-transitory computer-readable storage medium may cause the computing device to perform any one or more of the details set forth above regarding any of the aspects of embodiments of the method 300.

It will be appreciated that the method 300 may be implemented via the systems of FIGS. 1 and 2. To that end, illustrative systems 19 (FIG. 1) and 100 (FIG. 2) include a computer processor 21 (FIG. 1) and 120 (FIG. 2) respectively, a memory 22 (FIG. 1) and 130 (FIG. 2) respectively, a user interface 32, 33, 34, 35, 36, 44, and 45 (all FIG. 1) and 160, 161, 162, 163, 190, 191, 195, 196, and 197 (all FIG. 2) respectively, a haptic feedback device 61, 61A, and 61B (FIG. 1) and 198, 198A, and 198B (FIG. 2) respectively, and a computer program 30B (FIG. 1) and 146B (FIG. 2) respectively stored in the memory 22 (FIG. 1) and 130 (FIG. 2) respectively. The computer program 30B (FIG. 1) and 146B (FIG. 2) is configured to be executed by the computer processor 21 (FIG. 1) and 120 (FIG. 2) respectively to perform the method 300 including: receiving from an autocorrect module 30A (FIG. 1) and 146A (FIG. 2) respectively a first signal indicative of an autochange to user-entered text; comparing the autochange to a set of autochange attributes; generating a second signal with a haptic feedback module 30B (FIG. 1) and 146B (FIG. 2) respectively responsive to comparing the autochange to a set of autochange attributes; providing the second signal to the haptic feedback device 61, 61A, and 61B (FIG. 1) and 198, 198A, and 198B (FIG. 2) respectively; and generating haptic feedback with the haptic feedback device 61, 61A, and 61B (FIG. 1) and 198, 198A, and 198B (FIG. 2), respectively, responsive to the second signal. However, it will be appreciated that hardware implementation of the method 300 is not limited to the systems of FIGS. 1 and 2.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
receiving from an autocorrect module a first signal indicative of an autochange to user-entered text;
comparing the autochange to a set of autochange attributes;
generating a second signal with a haptic feedback module responsive to comparing the autochange to a set of autochange attributes;
providing the second signal to a haptic feedback device; and
generating haptic feedback with the haptic feedback device responsive to the second signal.

2. The method of claim 1, wherein the autochange includes a software-initiated change event chosen from a software-initiated-and-accomplished change to user-entered text and a software-initiated-and-recommended change to user-entered text.

3. The method of claim 1, wherein the second signal causes generation of haptic feedback with a haptic attribute that correlates with a property of the autochange.

4. The method of claim 3, wherein:
the second signal causes generation of haptic feedback with a first haptic attribute when the autochange has a first autochange property; and
the second signal causes generation of haptic feedback with a second haptic attribute that is different from the first haptic attribute when the autochange has a second autochange property.

5. The method of claim 4, wherein the first autochange property includes autocorrection and the second autochange property includes autocompletion.

6. (canceled)

7. The method of claim 3, wherein the haptic attribute includes at least one attribute chosen from proximity of haptic stimulation to a user's digit that entered text subject to the autochange, duration of haptic stimulation, type of haptic stimulation, location of haptic stimulation, distribution of haptic stimulation, intensity of haptic stimulation, and frequency of haptic stimulation.

8. (canceled)

9. The method of claim 1, wherein the autochange includes a software-initiated correction event to user-entered text.

10. The method of claim 9, wherein the software-initiated correction event to user-entered text includes a correction chosen from a spelling correction, a typographical error correction, a capitalization correction, a punctuation correction, a grammar correction, a spacing correction, and a formatting correction.

11. The method of claim 1, wherein the autochange includes a software-initiated autocompletion event to user-entered text.

12. The method of claim 1, wherein the autochange includes a software-initiated substitution event to user-entered text.

13. (canceled)

14. The method of claim 1, further comprising not generating the second signal responsive to comparing the autochange to a set of autochange attributes.

15-17. (canceled)

18. The method of claim 1, wherein generating the second signal responsive to comparing the autochange to a set of autochange attributes is further responsive to response from a user.

19. (canceled)

20. The method of claim 1, further comprising:
detecting at least one location of user interaction; and
wherein generating haptic feedback with the haptic feedback device responsive to the second signal includes generating haptic feedback proximate the location of user interaction with the haptic feedback device responsive to the second signal.

21. The method of claim 1, further comprising:
providing visual indication of an autochange.

22. The method of claim 21, wherein providing visual indication of an autochange includes:
providing a first visual indication upon initiation of an autochange; and
providing a second visual indication, that is different from the first visual indication, upon completion of the autochange.

23. The method of claim 1, further comprising:
providing non-haptic feedback to a user regarding at least one action chosen from accepting the autochange and rejecting the autochange.

24. A non-transitory computer-readable storage medium having stored therein instructions which, when executed by a computing device, cause the computing device to perform a method comprising:
receiving from an autocorrect module a first signal indicative of an autochange to user-entered text;
comparing the autochange to a set of autochange attributes;
generating a second signal with a haptic feedback module responsive to comparing the autochange to a set of autochange attributes;
providing the second signal to a haptic feedback device; and
generating haptic feedback with the haptic feedback device responsive to the second signal.

25. The non-transitory computer-readable storage medium of claim 24, wherein the autochange includes a software-initiated change event chosen from a software-initiated-and-accomplished change to user-entered text and a software-initiated-and-recommended change to user-entered text.

26. The non-transitory computer-readable storage medium of claim 24, wherein the second signal causes generation of haptic feedback with a haptic attribute that correlates with a property of the autochange.

27-31. (canceled)

32. The non-transitory computer-readable storage medium of claim 24, wherein the autochange includes a software-initiated correction event to user-entered text.

33-46. (canceled)

47. A system comprising:
a computer processor;
a memory;
a user interface;
a haptic feedback device; and
a computer program stored in the memory, wherein the computer program is configured to be executed by the computer processor to perform a method including:
receiving from an autocorrect module a first signal indicative of an autochange to user-entered text;
comparing the autochange to a set of autochange attributes;
generating a second signal with a haptic feedback module responsive to comparing the autochange to a set of autochange attributes;
providing the second signal to the haptic feedback device; and
generating haptic feedback with the haptic feedback device responsive to the second signal.

48. The system of claim 47, wherein the autochange includes a software-initiated change event chosen from a software-initiated-and-accomplished change to user-entered text and a software-initiated-and-recommended change to user-entered text.

49. The system of claim 47, wherein the second signal causes generation of haptic feedback with a haptic attribute that correlates with a property of the autochange.

50-63. (canceled)

64. The system of claim 47, wherein generating the second signal responsive to comparing the autochange to a set of autochange attributes is further responsive to response from a user.

65. (canceled)

66. (canceled)

67. The system of claim 47, wherein the method further includes:
providing visual indication of an autochange.

68-70. (canceled)

71. A non-transitory computer-readable storage medium having stored therein instructions executable by a computing device, the non-transitory computer-readable storage medium comprising:
first computer software program code means for receiving from an autocorrect module a first signal indicative of an autochange to user-entered text;
second computer software program code means for comparing the autochange to a set of autochange attributes;
third computer software program code means for generating a second signal responsive to comparing the autochange to a set of autochange attributes; and
fourth computer software program code means for causing the second signal to be provided to a haptic feedback device.

72. The non-transitory computer-readable storage medium of claim 71, wherein the autochange includes a software-initiated change event chosen from a software-initiated-and-accomplished change to user-entered text and a software-initiated-and-recommended change to user-entered text.

73. The non-transitory computer-readable storage medium of claim 71, wherein the second signal causes generation of haptic feedback with a haptic attribute that correlates with a property of the autochange.

74-80. (canceled)

81. The non-transitory computer-readable storage medium of claim 71, wherein the autochange includes a software-initiated autocompletion event to user-entered text.

82. The non-transitory computer-readable storage medium of claim 71, wherein the autochange includes a software-initiated substitution event to user-entered text.

83-93. (canceled)

94. A system comprising:
a user interface; and
a computer processor including:
a first computer processing component configured to receive from an autocorrect module a first signal indicative of an autochange to user-entered text;
a second computer processing component configured to compare the autochange to a set of autochange attributes; and
a third computer processing component configured to generate a second signal responsive to comparing the autochange to a set of autochange attributes; and
a haptic feedback device configured to generate haptic feedback responsive to the second signal.

95. The system of claim 94, wherein the autochange includes a software-initiated change event chosen from a software-initiated-and-accomplished change to user-entered text and a software-initiated-and-recommended change to user-entered text.

96. The system of claim 94, wherein the second signal causes generation of haptic feedback with a haptic attribute that correlates with a property of the autochange.

97-101. (canceled)

102. The system of claim 94, wherein the autochange includes a software-initiated correction event to user-entered text.

103. (canceled)

104. The system of claim 94, wherein the autochange includes a software-initiated autocompletion event to user-entered text.

105. The system of claim 94, wherein the autochange includes a software-initiated substitution event to user-entered text.

106-117. (canceled)
